(19) United States
(12) Patent Application Publication
(10) Pub. No.: US 2006/0096403 A1
(43) Pub. Date: May 11, 2006

(54) Bending mechanism using multi-joint slider link

(76) Inventors: Takeyoshi Dohi, Tokyo (JP); Nobuhiko Hata, Tokyo (JP); Hiromasa Yamashita, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/533,563

(22) PCT Filed: Apr. 30, 2003
(86) PCT No.: PCT/JP03/05522

§ 371 Date: Nov. 9, 2005

(30) Foreign Application Priority Data
Nov. 5, 2002 (JP) 2002-320931

(51) Int. Cl. B25J 7/00

(52) U.S. Cl. 74/490.04

(57) ABSTRACT

This invention provides a bending mechanism that performs a ±90 degrees bending motion per degree of freedom (DOF) simply by directly sliding a pair of a multi-slider linkage mechanisms and enables multi-degree-of-freedom (MDOF) bending by combining two or more said bending mechanisms. To serve the purpose, the first frame 1, the second frame 3 and the third frame 5 are linearly arrayed and sequentially mounted to be rotatable about the first and the second rotating shafts 2 and 4, respectively. The first drive link 7, the second drive link 9 and the third drive link 12 are connected to the first frame 1 on the right side of the first rotary shaft 2. The first restraining link 15 and the second restraining link 17 are connected to the first frame 1 on the left side of the first rotary shaft 2. The first frame 1 turns right and left as the third drive link 12 is driven and slides.

### TECHNICAL FIELD

This invention relates to a multi-degree-of-freedom (MDOF) bending mechanism using multi-slider linkage mechanisms. Specifically, this invention relates to a mechanism that achieves MDOF by combining two or more frames, each provided with a 90 degree bending mechanism on either side per degree of freedom. Drive power is transmitted by linkage mechanisms. The 2 degrees of freedom (2-DOF) manipulator of this invention features bending motion with excellent stiffness and durability and stable motion.

This invention can be used in all industrial fields. It can have applications in, for example, endoscopic surgical tools (e.g., endoscopes, forceps, cautery knives, etc. used in general surgery, thoracic surgery, obstetrics and gynecology, otolaryngology, urology, plastic surgery, orthopedics, brain surgery and any other surgical departments); remote-controlled robotic manipulators used in hazardous areas where humans are prohibited (nuclear power stations, outer space, etc.); tools for inspection and repair of parts located deep in large machines (such as engines) or complex parts of such machines without requiring disassembly and reassembly; remote-controlled instruments for inspection of thin piping in various facilities, medical equipment, nuclear power facilities and outer space; remote-controlled equipment for inspection of piping; and other inspection systems for complex piping in plants.

### BACKGROUND ART

Abdominal open surgery is increasingly being replaced by minimally invasive endoscopic surgical procedures. Conventional surgical tools used in endoscopic surgery such as forceps and cautery knives have limited degrees of freedom of motion with the point of insertion as the fulcrum. It is therefore impossible for the surgeon to approach the patient flexibly. To solve this problem, a long forceps manipulator for use in abdominal surgery has been proposed. Two-DOF bending is possible with this tool as it combines ring-like joints each featuring a 1-DOF rotary bearing driven by a wire (see, for example, non-patent literature 1).

This wire-driven tool effectively decreases the diameter of the manipulator and enables multi-channel operations. The shortcomings of this type of tool include its difficulty of achieving adequate stiffness and its insufficient durability typically caused by elongated wires.

To solve these problems, a pair of forceps with 2-DOF bending at the tip and 1-DOF rotation about its axis (total 3-DOF within the abdomen) with a linkage mechanism as the drive for achieving high stiffness has been proposed (see, for example, non-patent literature 2).

Non-patent literature 1: Literature on MDOF Long Forceps Manipulator: Ryoichi Nakamura, Etsuko Kobayashi et al: Development of Long Forceps Manipulator for Abdominal Surgery, Proc of Ninth Conference of Japan Society of Computer Aided Surgery, Secretariat for the Ninth Conference of Japan Society of Computer Aided Surgery, pp. 61-62, 2000

Non-patent literature 2: Literature on Link-Driven High Stiffness MDOF Active Forceps: Koichi Watabe, Masashi Okada, et al: Development of Link-Driven High Stiffness MDOF Active Forceps, Proc of '01 Lectures on Robotic Mechatronics, Japan Society of Mechanical Engineers, 2P1-D10 (1-2), 2001.

Despite these developmental efforts, unsolved problems remaining in conventional units have included their complex wire routing, complex and large-sized actuator and related parts for accurately controlling wire motion, slip-sticks due to the use of wires, backlash in the bending/extension motion, and relatively small working space compared with the diameter of the device.

To solve these problems in conventional units, the mechanism of this invention uses drive links and restraining links on both sides of frames that turn about rotary shafts to drive the bending motion by direct sliding only. This unique system also assures controlled sequential motion of the frames, improves operating accuracy and achieves stiffness, durability and a wide bending range.

### DISCLOSURE OF THE INVENTION

The technical means offered by this invention to achieve the above objectives are:

A 1-DOF bending mechanism with a multi-slider linkage mechanism in which multiple frames are arrayed linearly and mounted to rotate on each adjacent frame about a rotary shaft; rotatable and slidable drive links and restraining links are mounted on one side and on the other side, respectively, of the frames viewed from said rotary shaft; and said drive links are slid forward and backward by power to effect the bending motion of the frames;

A 1-DOF bending mechanism with a multi-slider linkage mechanism in which said multiple frames comprise the first, the second and the third frames; and the first and the second frames and the second and the third frames, respectively, are connected to and rotatable with each other about the first and the second rotary shaft, such that the first and the second frames are bent relative to the third frame;

A 1-DOF bending mechanism with a multi-slider linkage mechanism in which the top of the first drive link is mounted to be rotatable on the first frame on its one side viewed from the first rotary shaft by the first pin; the bottom of the first drive link is mounted to be rotatable on the top of the second drive link by the second pin; said second pin is then fitted into the first slot formed on the second frame; the bottom of said second drive link is mounted to be rotatable on the top of the third drive link by the third pin; said third pin is then fitted into the second slot formed on the third frame; the bottom of the third drive link is directly connected to an actuator; said actuator is connected to a power source; in which the top of the first restraining link is mounted to be rotatable on the first frame on its other side viewed from the first rotary shaft by the fourth pin; the bottom of the first restraining link is mounted to be rotatable on the top of the second restraining link by the fifth pin; said fifth pin is then fitted into the third slot formed on the second frame; the bottom of said second restraining link is mounted to be rotatable on the sixth pin; and said sixth pin is then fitted into the fourth slot formed on the third frame;

An MDOF bending mechanism with a multi-slider linkage mechanism comprising two 1-DOF bending mechanisms with a multi-slider linkage mechanism in which, in each of said bending mechanisms, said multiple frames are arrayed linearly and each frame is mounted to be rotatable on the adjacent frame about a rotary shaft; drive links and restraining links are mounted to be rotatable on one side and on the other side of the frames as viewed from the rotary shaft, respectively; said drive links are slid by power in the serial direction to effect the bending motion of multiple frames; and said two 1-DOF bending mechanisms with a multi-slider linkage mechanism are connected to each other with a phase difference of 90 degrees to effect an MDOF bending motion;

An MDOF bending mechanism with a multi-slider linkage mechanism in which the multiple frames of one of said two 1-DOF bending mechanisms comprises the first, the second and the third frames; the first and the second frames and the second and the third frames are connected to be rotatable with each other about the first and the second rotary shaft, respectively; the first and the second frames can be bent relative to the third frame; in which the multiple frames of the other of said two 1-DOF bending mechanisms comprise the fourth and the fifth frames which are connected to be rotatable with each other about the fourth rotary shaft; and the fourth frame of the other of the two 1-DOF bending mechanisms is connected to the third frame of one of the two 1-DOF bending mechanisms about the third rotary shaft with a phase difference of 90 degrees;

An MDOF bending mechanism with a multi-slider linkage mechanism in which, on the first frame on its one side viewed from the first rotary shaft, the top of the first drive link is mounted to be rotatable by the first pin; the bottom of the first drive link is mounted to be rotatable on the top of the second drive link by the second pin; said second pin is then fitted into the first slot formed on the second frame; the bottom of said second drive link is mounted to be rotatable on the top of the third drive link by the third pin; said third pin is then fitted into the second slot formed on the third frame; the bottom of the third drive link is connected to an actuator by pins via drive links; said actuator is connected to a power source; in which, on said first frame on its other side viewed from the first rotary shaft, the top of the first restraining link is mounted to be rotatable by the fourth pin; the bottom of the first restraining link is mounted to be rotatable on the top of the second restraining link by the fifth pin; said fifth pin is then fitted into the third slot formed on the second frame; the bottom of said second restraining link is mounted to be rotatable on the sixth pin; said sixth pin is then fitted into the fourth slot formed on the third frame; in which, furthermore, the fourth frame is mounted to be rotatable on said third frame about the third rotary shaft that is installed with a 90-degree phase difference with the first and the second rotary shafts; the fifth frame is mounted to be rotatable on the fourth frame about the fourth rotary shaft; the frames are arrayed linearly; in which, on one side of said third frame viewed from the third rotary shaft, the top of the fourth drive link is mounted to be rotatable by the seventh pin; the bottom of the fourth drive link is mounted to be rotatable on the top of the fifth drive link by the eighth pin; said eighth pin is then fitted into the fifth slot formed on the fourth frame; the bottom of said fifth drive link is mounted to be rotatable on the top of the sixth drive link by the ninth pin; said ninth pin is then fitted into the sixth slot formed on the fifth frame; the bottom of the sixth drive link is directly connected to an actuator which transmits the energy of the power source to the fifth drive link; in which, on the other side of said fourth frame viewed from the third rotary shaft, the top of the third restraining link is mounted to be rotatable by the tenth pin; the bottom of the third restraining link is mounted to be rotatable on the top of the fourth restraining link by the eleventh pin; said eleventh pin is then fitted into the seventh slot formed on the fourth frame; the bottom of said fourth restraining link is mounted to be rotatable by the twelfth pin; said twelfth pin is then fitted into the eighth slot formed on the fifth frame;

An MDOF bending mechanism with a multi-slider linkage mechanism in which each of said multiple frames is provided with a through-hole at the center and four (4) additional through-holes arrayed around the circumference of the central through-hole;

An MDOF bending mechanism with a multi-slider linkage mechanism in which, in said linearly arrayed multiple frames, the links for vertical bending and the links for horizontal bending are alternately installed in said four (4) through-holes arrayed around the circumference of the central through-hole, and a pair of forceps, endoscope or other equipment for manipulation is set in the central through-hole on the leading frame;

An MDOF bending mechanism with a multi-slider linkage mechanism in which the power source for the actuator that slides said frames is a hydraulic, oil-hydraulic or air-pressure cylinder or similar apparatus; said power source is connected to a control system by a wired or wireless connection via cables or an interface to enable remote control, and that is selected to configure the optimum system for the application; the location, speed, acceleration or force is fed back using sensors;

An MDOF bending mechanism with a multi-slider linkage mechanism in which said control system is designed to operate the actuator and control the location and position of and perform the kinematic calculation for the end effector; the equipment used for this purpose may be a controlling calculator, a personal computer, a microprocessor or similar device that is selected according to the expected volume of data to be processed and the operating environment (power supply, footprint, etc.); the remote control system uses leased lines or existing networks to control the system remotely; the operating interface may be a handheld, navigation or a master-slave type or similar device that is selected according to the application.

### BRIEF DESCRIPTION OF THE DRAWINGS

FIG. 1 is a schematic diagram of the link-driven 1-DOF bending mechanism of this invention.

FIG. 2 shows the operation of the link-driven 1-DOF bending mechanism of this invention.

FIG. 3 is a schematic diagram of the link-driven 2-DOF bending mechanism of this invention. FIG. 3 (a) is a plan and FIG. 3 (b) is a side view of the mechanism.

FIG. 4 (a) shows the tip of an endoscope provided with the link-driven 2-DOF bending mechanism of this invention. FIG. 4 (b) is the view from the arrow direction. FIG. 4 (c) is the cross-sectional channel of the endoscope provided with the link-driven 2-DOF bending mechanism of this invention.

FIG. 5 shows a pair of 2-DOF bending gripper forceps with the gripper mounted on the leading frame of the link-driven 2-DOF bending mechanism of this invention.

FIG. 6 shows the working space of the end effector mounted on the link-driven 2-DOF bending mechanism of this invention.

FIG. 7 shows typical examples of system configurations of this invention as it is embodied in various types of equipment.

### THE BEST MODES OF IMPLEMENTING THE INVENTION

The best modes of implementing this invention are described below.

(Mode of Implementation 1)

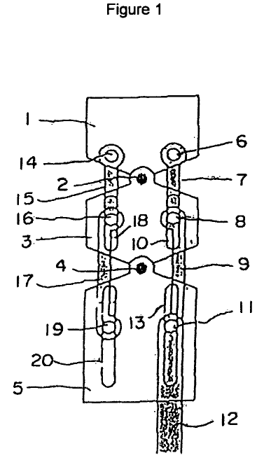

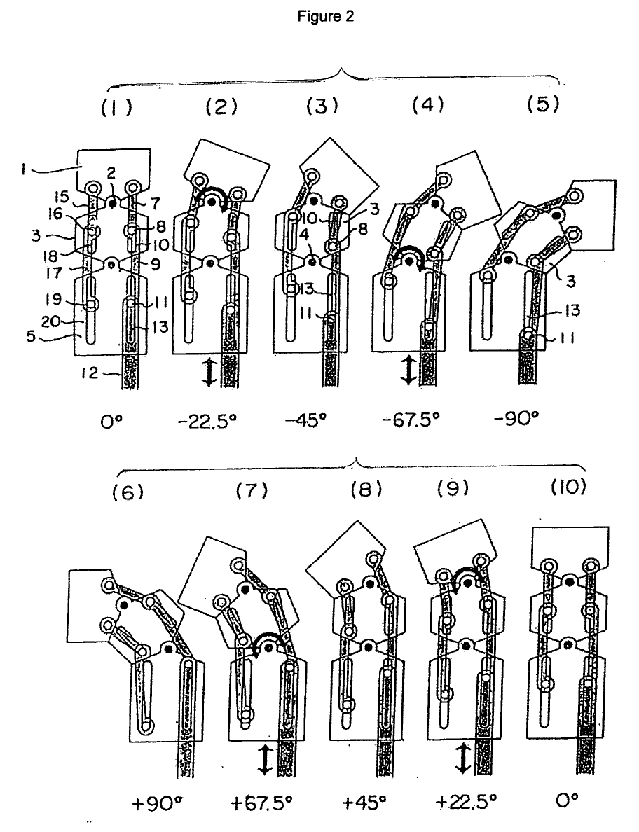

FIG. 1 is a schematic diagram of the link-driven 1-DOF bending mechanism. FIG. 2 shows the operation of the link-driven 1-DOF bending mechanism.

In this 1-DOF bending mechanism, the second frame 3 is mounted to be rotatable on the first frame 1 about the first rotary shaft 2, and the third frame 5 is mounted to be rotatable on the second frame 3 about the second rotary shaft 4. These frames are arrayed linearly.

The top of the first drive link 7 is mounted to be rotatable on the first frame 1 on its right side viewed from the first rotary shaft 2 by the first pin 6. The bottom of said first drive link 7 is mounted to be rotatable on the top of the second drive link 9 by the second pin 8. Said second pin 8 is then fitted into the first slot 10 formed on the second frame 3. The bottom of said second drive link 9 is mounted to be rotatable on the top of the third drive link 12 by the third pin 11. Said third pin 11 is then fitted into the second slot 13 formed on the third frame 5. The bottom of said third drive link 12 is directly connected to an actuator (not shown) to transmit energy from the power source to the second drive link 9.

The top of the first restraining link 15 is mounted to be rotatable on the first frame 1 on the left side viewed from the first rotary shaft 2 by the fourth pin 14. The bottom of said first restraining link 15 is mounted to be rotatable on the top of the second restraining link 17 by the fifth pin 16. Said fifth pin 16 is then fitted into the third slot 18 formed on the second frame 3. The sixth pin 19 is mounted on the bottom of said second restraining link 17 and said sixth pin is fitted into the slot 20 formed on the third frame 5.

The operation of the 1-DOF bending mechanism of the above configuration is described below referring to FIG. 2.

The first frame 1, when it is at zero degrees to the second frame 3 (FIG. 2 (1)), is driven by the power source (not shown). Energy from the power source is transmitted to the actuator (not shown) and then to the third drive link 12 which is directly coupled to the actuator. As the third drive link 12 moves, the third pin 11 moves down along the slot 13. As the third pin 11 moves down, the second drive link 9 also moves down. As the second drive link 9 moves down, the second pin 8 moves down along the first slot 10. As the second pin 8 moves down, the first drive link 7 also moves down. As the first drive link 7 moves, the first frame 1 is given torque and starts to turn clockwise about the first rotary shaft 2 (FIG. 2 (2)). The rotation continues until the second pin 8 contacts the lower edge of the first slot 10. When the second pin 8 contacts the lower edge of the first slot 10, the first frame 1 has turned −45 degrees relative to the second frame 3 (FIG. 2 (3)).

The restraining linkage on the left side of the first rotary shaft 2 on the first frame 1 follows the motion of the drive linkage. Specifically, as the first frame 1 turns clockwise, the first restraining link 15 moves upward while turning clockwise, and the fifth pin 16 also moves upward along the third slot 18. As the fifth pin 16 moves upward, the second restraining link 17 moves upward along the slot 20 formed on the third frame 5 together with the sixth pin 19 and follows the rotation of the first frame 1.

As explained above, when the second pin 8 reaches the lower end of the first slot 10 (FIG. 2 (3)), the second frame 3 is also given torque in the clockwise direction and starts to rotate about the second rotary shaft 4 (FIG. 2 (4)). The inclination increases as the third pin 11 moves downward along the slot 13. When the third pin 11 contacts the lower edge of the slot 13 (FIG. 2 (5)), the second frame 3 stops turning after having turned −45 degrees relative to the third frame 5 (FIG. 2 (5). As a result, the first frame 1 has turned −90 degrees relative to the third frame 5. An end effector (not shown) is to be mounted on the first frame 1.

Each frame is provided with pins, slots and links of the same shape. All these parts are arrayed symmetrically on both sides of the rotary shafts. Accordingly, just by moving the third drive link 12 in the opposite direction, the first frame 1 turns +90 degrees counterclockwise. A detailed written description of the motion is omitted as it is considered adequately explained visually in FIGS. 2 (6) through 2 (10).

### WORKING EXAMPLE 2

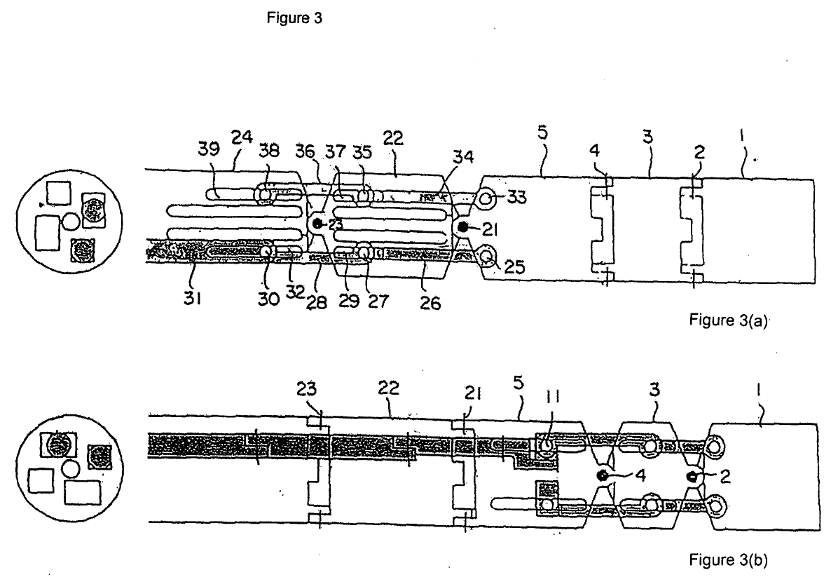

FIG. 3 is the schematic diagram of the link-driven 2-DOF bending mechanism of this invention. FIG. 3 (a) is a plan and FIG. 3 (b) is a side view. The same symbols and nomenclature used in Mode of Implementation 1 are used where the function and the shape are identical.

The link-driven 2-DOF bending mechanism in Mode of Implementation 2 of this invention is the same as that in Mode of Implementation 1 to the extent that the second frame 3 is mounted to be rotatable on the first frame 1 about the first rotary shaft 2 and the third frame 5 is mounted to be rotatable on the second frame 3 about the second rotary shaft 4 and that the frames are arrayed linearly.

As shown in FIGS. 3 (a) and 3 (b), the fourth frame 22 is mounted to be rotatable on the third frame 5 about the third rotary shaft 21. The fifth frame 24 is mounted to be rotatable on the fourth frame 22 about the fourth rotary shaft 23.

The above configuration enables the first frame 1 and the second frame 3 to be bent in the same direction relative to the third frame 5, or vertically (at right angles to the paper surface) and the fourth frame 22 and the fifth frame 24 to be bent in the same direction relative to the third frame 5, or horizontally (parallel to the paper surface). As explained earlier above, the fourth frame 22 and the fifth frame 24 are connected to the third frame 5 with a 90-degree phase difference so that the drive links mounted on the third pin 11 use two orthogonal pin joints (FIG. 3 (b)). This means that the drive link comprises multiple links as shown in FIG. 3 (b) and these links are mounted to be rotatable by pins to enable vertical bending (at right angles to the paper surface). Said drive links are connected to the actuator (not shown), and energy from the power source drives the first frame 1 and the second frame 3 to be bent vertically. The configuration of the fourth frame 22 and the fifth frame 24 that enable horizontal bending is described below referring to FIG. 3 (a).

The fourth frame 22 is mounted to be rotatable on the third frame 5 about the third rotary shaft 21. The fifth frame 24 is mounted to be rotatable on the fourth frame 22 about the fourth rotary shaft 23. These frames are arrayed linearly. The top of the fourth drive link 26 is mounted to be rotatable on the third frame 5 below the third rotary shaft 21 (FIG. 3 (a)) by the seventh pin 25. The bottom of said fourth drive link 26 is mounted to be rotatable on the top of the fifth drive link 28 by the eighth pin 27. The eighth pin 27 is then fitted into the fifth slot 29 formed on the fourth frame 22. The bottom of said fifth drive link 28 is mounted to be rotatable on the top of the sixth drive link 31 by the ninth pin 30. The ninth pin 30 is then fitted into the sixth slot 32 formed on the fifth frame 24. The bottom of the sixth drive link 31 is directly connected to an actuator (not shown) to transfer energy from the power source to the fifth drive link 28.

The top of the third restraining link 34 is mounted to be rotatable on the fourth frame 22 above the third rotary shaft 21 (FIG. 3 (a)) by the tenth pin 33. The bottom of said third restraining link 34 is mounted to be rotatable on the top of the fourth restraining link by the eleventh pin 35. The eleventh pin 35 is then fitted into the seventh slot 37 formed on the fourth frame 22. The bottom of the fourth restraining link 36 is mounted by the twelfth pin 38. Said twelfth pin 38 is then fitted into the eighth slot 39 formed on the fifth frame 24.

The operation of the 2-DOF bending mechanism of the above configuration is described below.

The operation is similar to that described above in Mode of Implementation 1 for the 1-DOF bending mechanism referring to FIG. 2. In FIG. 3 (a), energy of a power source (not shown) is transmitted to the actuator and then from the actuator to the sixth drive link 31 that is directly connected to the actuator. As the sixth drive link 31 moves, the ninth pin 30 moves to the left along the sixth slot 32. As the ninth pin 30 moves to the left, the fifth drive link 28 moves to the left. As the fifth drive link 28 moves to the left, the eighth pin 27 moves to the left along the fifth slot 29. As the eighth pin 27 moves to the left, the fourth drive link 26 also moves to the left. As the fourth drive link 26 moves to the left, the third frame 5 is given torque and starts to turn clockwise about the third rotary shaft 21. The rotation continues until the eighth pin 27 contacts the left edge of the fifth slot 29. When the eighth pin 27 reaches the left edge of the fifth slot 29, the third frame 5 has turned −45 degrees relative to the fourth frame 22. In like manner as stated above referring to FIG. 2, the fourth frame 22 turns −45 degrees relative to the fifth frame 24. As a result, the third frame 5 turns −90 degrees relative to the fifth frame 24. In like manner as stated above, the first frame 1 and the second frame 3 turn vertically relative to the third frame 5 that has turned −90 degrees horizontally. This combined motion takes place smoothly without interference because all related components such as link mechanisms, slots, pins, etc. responsible respectively for horizontal and vertical bending are arrayed with a 90-degree phase difference to each other.

### WORKING EXAMPLE 1

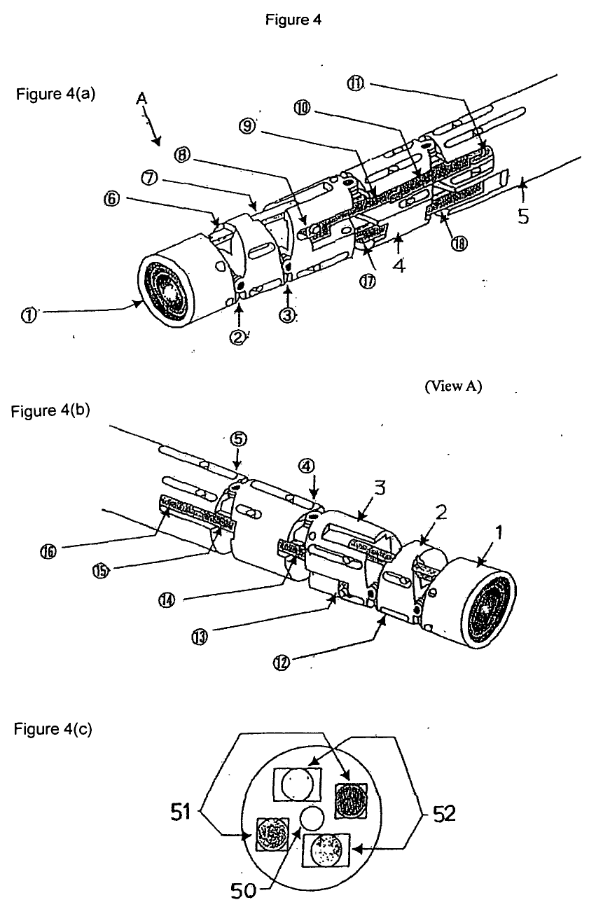

FIG. 4 (a) shows the tip of a 2-DOF bending endoscope. The endoscope is installed on a 2-DOF bending mechanism that consists of two 1-DOF bending mechanisms of this invention. FIG. 4 (b) shows the system viewed from the arrow direction. FIG. 4 (c) is the cross-sectional view of the frames.

Each of the frames 1 through 5, shown by the numbers 1 through 5 in FIG. 4 (c), is provided with a through-hole 50 at the center and four through-holes 51 and 52 arrayed around the circumference of said central through-hole 50 (see FIG. 4 (c)). Said central through-hole 50 is reserved for installing a CCD camera. Two of the four through-holes arrayed around the circumference of the central through-hole are used for passing links for horizontal bending 51. The other two are for passing links for vertical bending 52. The four holes are alternately used for links for vertical and horizontal bending, respectively. The restraining links (12) and (13) (hidden) in the vertical bending linkage are arrayed symmetrically with the drive links (6) and (7), respectively. Said frames are provided with cutouts in the body as appropriate to facilitate assembly of links or prevent interference of links in operation. The frames and the links are connected by pin joints. The frames for the bending mechanism we manufactured are 9 mm in diameter. A shield was then applied to the frame to produce an endoscope 10 mm in diameter. We are currently developing a high-accuracy endoscopic surgical tool incorporating a CCD camera and a gripper built into 10-mm diameter frames. Specifically, we achieved a highly accurate average repetitive error of ±0.9 degrees in the bending range of ±80 degrees per degree of freedom. The table below explains the operation of the components. The functions are identical for both 1-DOF and 2-DOF bending mechanisms.

Table 1 identifies the components shown in FIG. 4 by circled numbers and the function of the components.

TABLE 1

| Components | No. | Function | |
|---|---|---|---|
| CCD camera | (1) | View the object in | Rotary shaft 1 for |
| | | front of Frame 1 | vertical bending |
| | (2) | Frame 1 turns about | Rotary shaft 2 for |
| | | this shaft | vertical bending |
| | (3) | Frame 2 turns about | Rotary shaft 1 for |
| | | this shaft | horizontal bending |
| | (4) | Frame 3 turns about | Rotary shaft 2 for |
| | | this shaft | horizontal bending |
| | (5) | Frame 4 turns about | |
| | | this shaft | |
| Links for | | | |
| vertical | | | |
| bending | | | |
| Drive link 1 | (6) | Gives moment to frame | |
| | | 1 to make it turn | |
| | | about rotary shaft 1. | |
| Drive link 2 | (7) | Gives moment to frame | |
| | | 2 to make it turn | |
| | | about rotary shaft 2. | |
| Drive link 3 | (8) | Connects drive links 2 | |
| | | and 4 in frame 3. | |
| | | Serves as a universal | |
| | | joint. | |
| Drive link 4 | (9) | Transmits power from | |
| | | drive link 5 to drive | |
| | | link 3. | |
| Drive link 5 | (10) | Transmits power from | |
| | | drive link 6 to drive | |
| | | link 4. | |
| Drive link 6 | (11) | Transmits energy from | |
| | | power source to drive | |
| | | link 5. Directly | |
| | | connected to actuator. | |
| Restraining | (12) | Features the same | Restrains and makes |
| link 1 | | shape as, and | frames 1 and 2 turn |
| | | symmetrical motion | in the specified |
| | | with, drive link 1. | sequence. |
| Restraining | (13) | Features the same | Restrains and makes |
| link 2 | | shape as, and | frames 1 and 2 turn |
| | | symmetrical motion | in the specified |
| | | with, drive link 2. | sequence. |
| Links for | | | |
| horizontal | | | |
| bending | | | |
| Drive link 1 | (14) | Gives moment to frame | |
| | | 3 to make it turn | |
| | | about rotary shaft 3. | |
| Drive link 2 | (15) | Gives moment to frame | |
| | | 4 to make it turn | |
| | | about rotary shaft 4. | |
| Drive link 3 | (16) | Transmits energy from | |
| | | power source to drive | |
| | | link 3. Directly | |
| | | connected to | |
| | | actuator. | |
| Restraining | (17) | Features the same | Restrains and makes |
| link 1 | | shape as, and | frames 3 and 4 turn |
| | | symmetrical motion | in the specified |
| | | with, drive link 1. | sequence. |
| Restraining | (18) | Features the same | Restrains and makes |
| link 2 | | shape as, and | frames 3 and 4 turn |
| | | symmetrical motion | in the specified |
| | | with, drive link 2. | sequence. |

### WORKING EXAMPLE 2

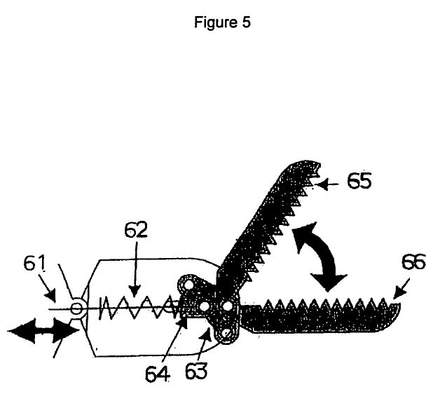

FIG. 5 shows a gripper forceps installed on the leading frame of a 2-DOF bending mechanism of this invention via a gripper mechanism. The operating principle is same as that of the 2-DOF bending endoscope shown in FIG. 4. The working channel is used for passing lead wires for an endoscope or a metal wire 61 (for gripper operation) for a gripper forceps. The metal wire 61 and the spring 62 together drive the gripper mechanism. When the wire 61 is pulled, the upper teeth close via gripper links 64 and 63, and engage with the lower teeth 66. When the wire 61 is released, the upper teeth 65 open by the return force of the spring 62.

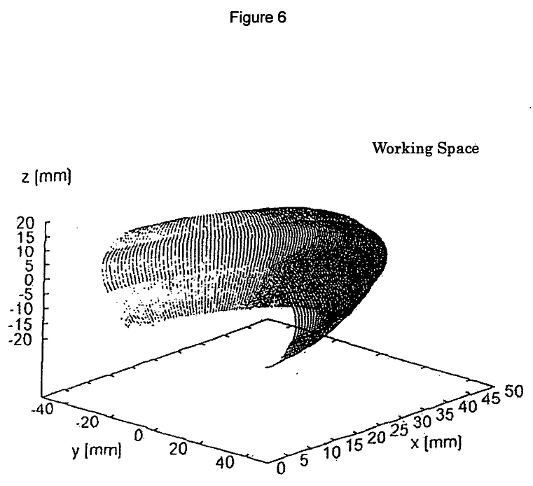

Working space of an end effector is described referring to FIG. 6.

An end effector was mounted on the leading edge of the 2-DOF bending mechanism shown in FIG. 4. It is positioned 10 mm from the rotary shaft for vertical bending. The lengths of the frames 2, 3 and 4 were 7.92 mm, 12.54 mm and 13.4 mm, respectively. FIG. 6 shows the working space of the end effector mounted on the above 2-DOF bending mechanism. The origin (0, 0, 0) represents the position of the rotary shafts for horizontal bending on the actuator side.

### WORKING EXAMPLE 3

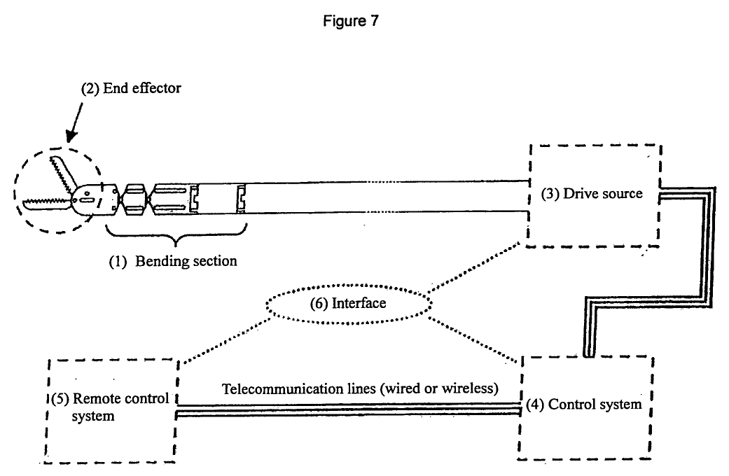

FIG. 7 shows typical examples of the system configuration for incorporating this invention into various types of equipment. The functions of the components are described below. (1) Bending Section: 1-DOF or 2-DOF bending mechanism is used in principle. A 3-DOF or greater bending mechanism may also be devised. Bending range is ±90 degrees maximum per degree of freedom; (2) End Effector: A camera, various types of forceps, cautery knife, laser or other device can be mounted; (3) Drive Source: The drive source for the links includes, for example, an actuator and a hydraulic, oil-hydraulic or air-pressure cylinder. The most suitable driver for the given application or specifications should be selected. Various sensors are used to feed back the data on position, speed, acceleration and kinesthetic sense; (4) Control System: Various control systems are available including controlling calculators, personal computers and microprocessors. The most suitable system is selected considering the expected volume of data to be processed and the operating environment (power supply, footprint, etc.). The control system is also used to control the actuator, control the position and location of the end effector and perform kinematic calculation; (5) Remote Control System: Remote control is enabled using leased lines or existing networks; and (6) Interface: the operating interface may be a handheld, navigation or master-slave type or similar device that is selected according to the application.

In the above working examples of this invention, the 2-DOF bending mechanism is used for forceps and endoscope applications. In addition, this invention can have applications in, for example, endoscopic surgical tools (e.g., endoscopes, forceps, cautery knives, etc. used in general surgery, thoracic surgery, obstetrics and gynecology, otolaryngology, urology, plastic surgery, orthopedics, brain surgery and any other surgical departments); remote-controlled robotic manipulators used in hazardous areas where humans are prohibited (nuclear power stations, outer space, etc.); tools for inspection and repair of parts located deep in large machines (such as engines) or complex parts of such machines without requiring disassembly and reassembly; remote-controlled instruments for inspection of thin piping in various facilities, medical equipment, nuclear power facilities and outer space; remote-controlled equipment for inspection of piping; and other inspection systems for complex piping in plants.

This invention may be implemented in various other forms of embodiment without deviating from the spirit of its main features. The above-mentioned working examples are therefore only a few examples and should not be construed as limiting.

### INDUSTRIAL APPLICABILITY

Because of the unique features of the 1-DOF bending mechanism with the multi-slider linkage mechanism of this invention, namely, that the multiple frames are arrayed linearly and mounted to be rotatable on the adjacent frames about a rotary shaft located on the centerline of the frames; drive links and restraining links are mounted to be rotatable and slidable on one side and on the other side, respectively, of the frames viewed from said rotary shaft; and said drive links are slid by power forward and backward to effect bending motion of the frames; the bending operation of ±90 degrees per degree of freedom on either side is achieved simply by controlling and sliding one single link to provide a wide working space for the user. By combining two or more bending mechanisms with the multi-slider linkage mechanism of this invention, a small device with MDOF bending mechanisms can be fabricated. Because of the above unique construction of this invention, a high bending reproducibility free from backlash and slip-sticks is realized. A large power for bending is obtainable because the linkage is directly driven. This invention has many other outstanding effects such as excellent stiffness and durability and highly stable motion.

1. A 1-DOF bending mechanism with a multi-slider linkage mechanism in which the multiple frames are arrayed linearly and mounted to be rotatable on each adjacent frame about a rotary shaft; drive links and restraining links are mounted to be rotatable and slidable on one side and on the other side, respectively, of the frames viewed from said rotary shaft; and said drive links are slid by power forward and backward to effect the bending motion for the frames.

2. A 1-DOF bending mechanism with a multi-slider linkage mechanism as claimed in claim 1 in which said multiple frames comprise the first, the second and the third frames; the first and the second frames and the second and the third frames are connected to be rotatable with each other by the first and the second rotary shaft, respectively; and the first and the second frames can be bent relative to the third frame.

3. A 1-DOF bending mechanism with a multi-slider linkage mechanism as claimed in claims 1 or 2 in which the top of the first drive link is mounted to be rotatable on the first frame on its one side viewed from the first rotary shaft by the first pin; the bottom of the first drive link is mounted to be rotatable on the top of the second drive link by the second pin; said second pin is then fitted into the first slot formed on the second frame; the bottom of said second drive link is mounted to be rotatable on the top of the third drive link by the third pin; said third pin is then fitted into the second slot formed on the third frame; the bottom of the third drive link is directly connected to an actuator; said actuator is connected to a power source; in which the top of the first restraining link is mounted to be rotatable on the first frame on its other side viewed from the first rotary shaft by the fourth pin; the bottom of the first restraining link is mounted to be rotatable on the top of the second restraining link by the fifth pin; said fifth pin is then fitted into the third slot formed on the second frame; the bottom of said second restraining link is mounted to be rotatable by the sixth pin; and said sixth pin is then fitted into the fourth slot formed on the third frame.

4. An MDOF bending mechanism with a multi-slider linkage mechanism comprising two 1-DOF bending mechanisms with a multi-slider linkage mechanism in which, in each of said bending mechanisms, multiple frames are arrayed linearly and each frame is mounted to be rotatable on the adjacent frame about a rotary shaft; drive links and restraining links are mounted to be rotatable on one side and on the other side of the frames as viewed from the rotary shaft, respectively; said drive links are slid by power in the serial direction to effect the bending motion of the multiple frames; and said two 1-DOF bending mechanisms with a multi-slider linkage mechanism are connected to each other with a phase difference of 90 degrees to effect MDOF bending motion.

5. An MDOF bending mechanism with a multi-slider linkage mechanism as claimed in claim 4 in which the multiple frames of one of said two 1-DOF bending mechanisms comprises the first, the second and the third frames; the first and the second frames and the second and the third frames are connected to be rotatable with each other about the first and the second rotary shaft, respectively; the first and the second frames can be bent relative to the third frame; and in which the multiple frames of the other of said two 1-DOF bending mechanisms comprises the fourth and the fifth frames which are connected to be rotatable with each other about the fourth rotary shaft; and the fourth frame of the other of the two 1-DOF bending mechanisms is connected to the third frame of one of the two 1-DOF bending mechanisms about the third rotary shaft with a phase difference of 90 degrees.

6. An MDOF bending mechanism with a multi-slider linkage mechanism as claimed in claims 4 or 5 in which, on the first frame on its one side viewed from the first rotary shaft, the top of the first drive link is mounted to be rotatable by the first pin; the bottom of the first drive link is mounted to be rotatable on the top of the second drive link by the second pin; said second pin is then fitted into the first slot formed on the second frame; the bottom of said second drive link is mounted to be rotatable on the top of the third drive link by the third pin; said third pin is then fitted into the second slot formed on the third frame; the bottom of the third drive link is connected to an actuator by pins via drive links; said actuator is connected to a power source; in which, on said first frame on its other side viewed from the first rotary shaft, the top of the first restraining link is mounted to be rotatable by the fourth pin; the bottom of the first restraining link is mounted to be rotatable on the top of the second restraining link by the fifth pin; said fifth pin is then fitted into the third slot formed on the second frame; the bottom of said second restraining link is mounted to be rotatable by the sixth pin; said sixth pin is then fitted into the fourth slot formed on the third frame; in which, furthermore, the fourth frame is mounted to be rotatable on said third frame about the third rotary shaft that is installed with a phase difference of 90 degrees relative to the first and the second rotary shafts; the fifth frame is mounted to be rotatable on the fourth frame about the fourth rotary shaft; the frames are arrayed linearly; in which, on one side of said third frame viewed from the third rotary shaft, the top of the fourth drive link is mounted to be rotatable by the seventh pin; the bottom of the fourth drive link is mounted to be rotatable on the top of the fifth drive link by the eighth pin; said eighth pin is then fitted into the fifth slot formed on the fourth frame; the bottom of said fifth drive link is mounted to be rotatable on the top of the sixth drive link by the ninth pin; said ninth pin is then fitted into the sixth slot formed on the fifth frame; the bottom of the sixth drive link is directly connected to an actuator which transmits energy from the power source to the fifth drive link; in which, on the other side of said fourth frame viewed from the third rotary shaft, the top of the third restraining link is mounted to be rotatable by the tenth pin; the bottom of the third restraining link is mounted to be rotatable on the top of the fourth restraining link by the eleventh pin; said eleventh pin is then fitted into the seventh slot formed on the fourth frame; the bottom of said fourth restraining link is mounted to be rotatable by the twelfth pin; and said twelfth pin is then fitted into the eighth slot formed on the fifth frame.

7. An MDOF bending mechanism with a multi-slider linkage mechanism as claimed in any one of claims 1, 2, 4 and 5 in which each of said multiple frames is provided with a through-hole at the center and four (4) additional through-holes arranged around the circumference of the central through-hole.

8. An MDOF bending mechanism with a multi-slider linkage mechanism as claimed in any one of claims 1, 2, 4 and 5 in which on said multiple frames arrayed linearly the linkage for vertical bending and that for horizontal bending are alternately installed in said four (4) through-holes arrayed around the circumference of the central through-hole and a pair of forceps, endoscope or other equipment for manipulation is set in the central through-hole on the leading frame.

9. An MDOF bending mechanism with a multi-slider linkage mechanism as claimed in any one of claims 1, 2, 4 and 5 in which the power source for the actuator to slide the frames is a hydraulic, oil-hydraulic or air-pressure cylinder or similar apparatus; said actuator is connected to a control system by a wired or a wireless system with cables or interface to enable remote control and the optimum system is selected according to the application; and the location, speed, acceleration or force is fed back using sensors.

10. An MDOF bending mechanism with a multi-slider linkage mechanism as claimed in any one of claims 1, 2, 4 and 5 in which said control system is designed to operate the actuator and control the location and position of and perform the kinematic calculation for the end effector, which may be a controlling calculator, a personal computer, a microprocessor or similar device that is selected according to the expected volume of data to be processed and the operating environment (power supply, footprint, etc.); the remote control system uses leased lines or existing networks to control the system remotely; and the operating interface may be a handheld, navigation or master-slave type or similar device that is selected according to the application.
